(19) United States
(12) Patent Application Publication
(10) Pub. No.: US 2002/0007547 A1
(43) Pub. Date: Jan. 24, 2002

(54) PROCESS AND DEVICE FOR PRODUCING A PIPE PRESS-FITTED CONNECTION

(76) Inventors: HEINZ UNEWISSE, MULHEIM (DE); MARIA UNEWISSE, MULHEIM (DE); HERBERT FOERING, SOLINGEN (DE); RAINER FRANZEN, KREFELD (DE)

Correspondence Address: THOMAS C PONTANI, COHEN PONTANI LIEBERMAN & PAVANE, 551 FIFTH AVENUE, SUITE 1210, NEW YORK, NY, 10176

(21) Appl. No.: 09/180,401

(22) PCT Filed: Apr. 18, 1997
(86) PCT No.: PCT/DE97/00816

(30) Foreign Application Priority Data
May 8, 1996 (DE) 196 20 165.9

(51) Int. Cl. B23P 11/00

(52) U.S. Cl. 29/516; 29/525

(57) ABSTRACT

The invention relates to a process for producing a press-fitted pipe connection comprising a press fitting with a stop and a smooth-ended pipe section pressable therewith, in which, after the pipe section is cut, its cut end is trimmed inside and outside and, if necessary, the protective cover of the pipe is removed, the processed pipe end is inserted into the press fitting to the stop and the press fitting is then pressed, by means of a pressing tool with individual pressing jaws that encompass the press fitting, after application of the pressing tool in a force-locking and positive-locking fashion, with the inserted pipe section to form a non-detachable tight pipe connection, whereby toward the end of the pressing the individual pressing jaws complete each other to form a closed pressing chamber. During pressing, in the contact area of at least one pressing jaw with the outer surface of the press fitting, a characteristic stamping is formed, the appearance of which depends on the quality of the pressing.

The invention relates to a process for producing a press-fitted pipe connection comprising a press fitting with a stop and a smooth-ended pipe section pressable therewith in accordance with the generic part of the main claim.

The press-fitting system that has long been marketed by Mannesmann AG (see the company brochure “Mannesmann Press-Fitting System/Sanitary, Working and Installation Guidelines for Pipes and Press Fittings of Stainless Steel for Drinking Water, Edition of August 1994” [Mannesmann Pressfiffing-System/Sanitaer, Arbeits- und Verlegerichtlinie fuer Rohre und Pressfittings aus nichtrostendem Stahl fuer die Trinkwasserinstallation, Ausgabe 8/1994]) consists essentially of three components, namely:

the press fitting

the pipe

the pressing device, including the pressing annulus or pressing clamp with the pressing jaws arranged therein.

After the smooth-ended pipe section is cut, its end area is trimmed inside and outside and, if necessary, the plastic cover protecting the pipe is removed. The smooth-ended pipe section is then inserted into the press fitting, and pressing is carried out with the pressing tool. In a correct pressing process, the fitting and the pipe are clamped together in non-detachable fashion, on the strength level. At the same time, on the tightness level, the press-fitting bulge is deliberately deformed in such a way that the sealing ring attains a deformation specified by the system supplier. Such a connection can function permanently.

A comparable press-fitting system is disclosed in U.S. Pat. No. 5,484,174. In contrast to the system described above, this press fitting has a virtually cylindrical section extending toward the insertion side. The pressing tool has a pressing groove with two pressing pieces arranged in the end areas. The distance between the two pressing pieces is selected in such a way that, after placement of the pressing tool-whereby the annular bulge of the press fitting serves as centering-, only one pressing piece can act upon la the press fitting. In addition, the press fitting has, in the area facing away from the insertion side, a section with a smaller diameter, which section simultaneously serves as a stop for the pipe to be inserted. After the pressing jaws are closed, one of the two pressing pieces arranged on the pressing tool forms multiple depressions that are arranged distributed around the circumference and that act in the sense of axial cramping on the pipe located thereunder.

However, depending on the tolerances of the individual components, the impressions on the levels of strength and tightness are of different depths. The system provider, based on years of experience, knows what impressions are needed to attain the required strength and permanent tightness. The following points indicate the influence of component tolerances as well as the interaction of the pressing device and the press fitting.

If the outer diameter of the pipe is too small, pressing the fitting does not ensure the connection of the pipe and the fitting and does not sufficiently deform the press-fitting bulge and sealing ring.

If the pressing chamber, i.e., the pressing jaw, is not fully closed, the pressing jaw profile is not completely transferred to the press fitting. As a result, pressing does not occur properly on either the strength or the tightness level. The momentary strength and tightness of such a pipe connection does not imply its permanent functional capability.

However, closed pressing jaws can only be achieved when the pressing device is precisely adjusted, with respect to geometry and forces, to the geometry of the pressing jaw; here, too, tolerances must be taken into account.

Thus, in a press-fitting system, it is not only the fittings and pipes with their narrow tolerances, but also, in particular, the pressing jaw and its set contour and the associated pressing tools designed for long-term operation that guarantee the success of a correct and permanently functional pipe connection. The consequence of this is that each press-fitting die requires a specific pressing jaw contour. This is the only way to ensure that after pressing, the sealing rings will have the compression that guarantees permanent tightness.

When press fittings and pressing jaws of different systems are combined, press-fitting contours result that cannot meet the requirement of strength or, in particular, of permanent tightness.

In view of this problem, operators of such press-fitting systems want to be able to recognize as simply and reproducibly as possible whether proper pressing has taken place.

The object of the invention is to indicate a process and a device for producing a press-fitted pipe connection, with which correct and permanently functional pressing can be simply recognized.

This object is attained by means of the features indicated in the characterizing part of the main claim. Advantageous further developments as well as a device for implementing the process are the subject of subclaims.

According to the invention, in the contact area of at least one pressing jaw with the outer surface of the press fitting, a characteristic stamping is plastically formed during pressing, the appearance of which depends on the quality of the pressing. This means that when components approved by the system provider are used, including pressing jaws and pressing tools, and when the pressing jaws close completely, the characteristic stamping achieves its proper appearance. In all other cases, the appearance is incomplete. This can be recognized immediately. In such cases, a check must be made to determine whether components approved by the system provider (which usually have a manufacturer-assigned designation) were used and whether the pressing jaws were completely closed toward the end of the pressing. The creation of a characteristic stamping according to the invention is an aid to allow the quality of the pressing to be simply checked.

The characteristic stamping can be produced by means of a recess running substantially in the pressing direction in the pressing piece. The quality of the pressing determines the appearance of the stamping in that the stamping achieves its proper appearance (in height and shape) only when components approved by the system provider are used and the pressing jaws are completely closed. In all other cases, the stamping will be visibly and recognizably incomplete. This makes it possible for the inspector authorized by the construction master to visually inspect all pressing points after pressing and to evaluate the appearance of the characteristic stamping. In doubtful cases, the questionable pressing point should be further inspected and, if necessary, removed.

An example of the process according to the invention is described in greater detail in reference to the drawings. The drawings show:

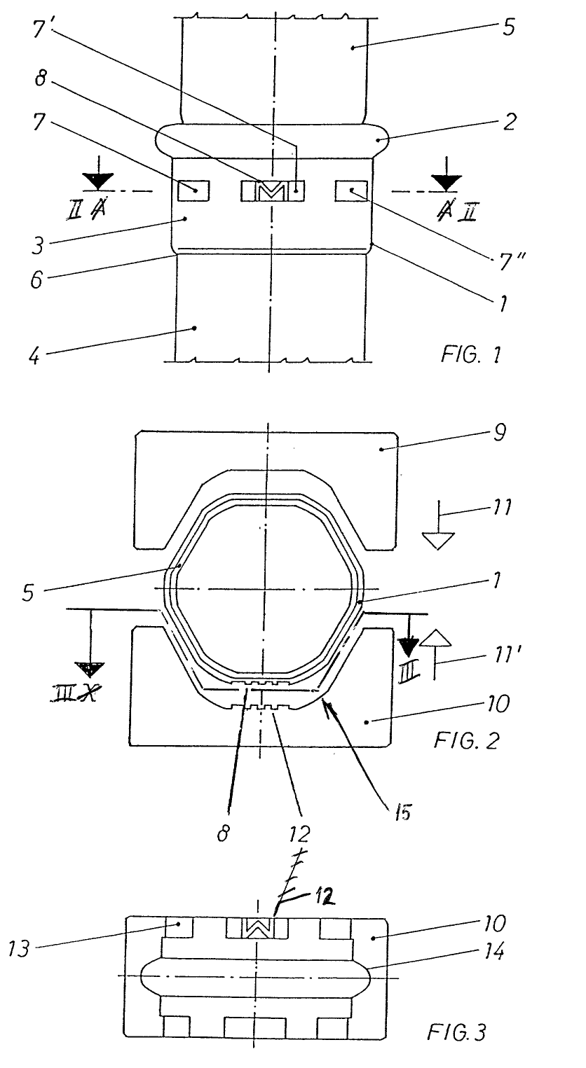

FIG. 1 A partial section of a properly pressed pipe connection;

FIG. 2 A section in Direction A-A as in FIG. 1 with the associated pressing tool;

FIG. 3 A view in Direction X as in FIG. 2.

FIG. 1 shows a partial view of a properly pressed pipe connection. This connection consists of the press fitting 1, which has a bead-like bulge 2, a first cylindrical section 3 and a second cylindrical section 4. The length of the first cylindrical section 3 corresponds roughly to the required insertion depth of the pipe 5 to be connected, whereby the diameter step to the adjacent second cylindrical section 4 forms a stop 6 for the pipe 5 being inserted. Arranged in the bead-like bulge 2 is a sealing ring, which is not visible in this drawing. The plastic deformation of the bulge 2 causes the sealing ring to be chambered in so strongly that the sealing ring comes to rest with suitable prestress along the contact surface and ensures hydraulic impermeability. Axial protection against an outward movement by the pipe is provided by means of a hexagonal pressing in the first cylindrical section 3, for example. The remaining visible pressings 7, 7′, 7″ form rectangular surfaces and are also present on the back side, not shown here. According to the invention, a characteristic stamping 8 is created in this area of contact between the pressing tool and the press fitting 1. In this example, the characteristic stamping is a stylized capital M. The appearance of the characteristic stamping depends on the quality of the pressing, as already discussed in detail in this description.

FIG. 2 shows the properly pressed pipe connection as in FIG. 1 in a section in Direction A-A. For the sake of clarity, the pressing tool, which in this example consists of two pressing jaws 9, 10, is also indicated in this drawing. The open arrows 11, 11′ show that the two pressing jaws 9, 10 move toward each other during pressing. The characteristic stamping 8 plastically formed on the cylindrical section 3 of the press fitting 1 can be clearly seen, as can the corresponding recess 12 in the lower pressing jaw 10.

FIG. 3 also shows the recess 12 in the pressing piece 13. The contoured recess 14 for forming the bulge 2 is also shown in this drawing.

1. Process for producing a press-fitted pipe connection comprising a press fitting with a stop and a smooth-ended pipe section pressable therewith, in which, after the pipe section is cut, its cut end is trimmed inside and outside and, if necessary, the protective layer protecting the pipe is removed, then the processed pipe is inserted into the press fitting to the stop and the press fitting is then pressed, by means of a pressing tool with individual pressing jaws that encompass the press fitting, after application of the pressing tool in a force-locking and positive-locking manner, with the inserted pipe section to form a non-detachable tight pipe connection, whereby toward the end of the pressing, the individual pressing jaws complete each other to form a closed pressing chamber, and depressions also encompassing the pipe section are also formed distributed around the circumference at least on one plane,
characterized by the fact
that during pressing, in the contact area of at least one pressing jaw with the outer surface of the press fitting, a characteristic stamping is plastically created, the appearance of which depends on the quality of the pressing.

2. Process as in claim 1,
characterized by the fact
that the characteristic stamping is formed in a raised fashion.

3. Device for implementing the process as in claim 1,
with a press fitting, which has at least one section holding a sealing ring in bulge-like fashion in cross-section and a cylindrically embodied region connected thereto, which at the end of its extension is equipped with a bead-like depression,
and with a smooth-ended end region of a pipe section insertable into the press fitting to the stop and pressable therewith,
as well as with a pressing annulus or pressing clamp having individual pressing jaws and encompassing the press fitting,
whereby a pressing groove running in the circumferential direction is molded into the pressing jaws on the inside, and a pressing piece runs along at least one side of the pressing groove,
characterized by the fact
that in the pressing piece (13) of at least one pressing jaw (10), a recess (12) lying substantially in the pressing direction is provided.

4. Device as in claim 3,
characterized by the fact
that the recess (12) has the shape of a characteristic stamping.

5. Device as in claims 3 and 4,
characterized by the fact
that the recesses are distributed symmetrically across the pressing chamber.

6. Device as in one of the claims 3 through 5,
characterized by the fact
that the recess (12) is arranged in the crown area of the segment of the given pressing jaw (10).
